(19) United States
(12) Patent Application Publication
(10) Pub. No.: US 2005/0260861 A1
(43) Pub. Date: Nov. 24, 2005

(54) Method for evaluating semiconductor substrate

(75) Inventor: Toru Yamazaki, Saga (JP)

Correspondence Address: HESLIN ROTHENBERG FARLEY & MESITI PC, 5 COLUMBIA CIRCLE, ALBANY, NY, 12203, US

(73) Assignee: Sumitomo Mitsubishi Silicon Corporation, Tokyo (JP)

(21) Appl. No.: 11/134,991

(22) Filed: May 23, 2005

(30) Foreign Application Priority Data
May 21, 2004 (JP) 2004-152195

(51) Int. Cl. G11B 9/00

(52) U.S. Cl. 438/745

(57) ABSTRACT

A method for evaluating a semiconductor substrate includes the steps of cleaning the semiconductor substrate with SPM, attaching a liquid metal electrode to a surface of the semiconductor substrate, and applying a voltage to the semiconductor substrate.

### BACKGROUND OF THE INVENTION

1. Field of the Invention

The present invention relates to methods for evaluating a semiconductor substrate by attaching a liquid metal electrode to a surface thereof.

2. Description of the Related Art

In recent years, the demand for higher reliability on semiconductor layers, such as silicon layers, and insulating films, such as silicon oxide films, has been growing with increasing packing density of, for example, LSIs having a metal-insulator-semiconductor (MIS) structure. Under such circumstances, the electrical characteristics of semiconductor layers and insulating films included in semiconductor substrates are evaluated by evaluation methods in which an electrode made of a liquid metal such as mercury is attached to a surface of a semiconductor substrate to achieve higher evaluation accuracy. Such methods have been proposed in, for example, the following documents: U.S. Pat. No. 6,429,145 (Paragraphs 2 to 6, FIG. 2); U.S. Pat. No. 6,548,420 (Paragraphs 2 and 3); and “IEEE Transactions on Electron Devices,” Vol. 47, No. 5, May 2000, IEEE International SOI Conference, October 1997.

### SUMMARY OF THE INVENTION

The present inventors have studied methods for evaluating the electrical characteristics of a semiconductor substrate by attaching a liquid metal electrode to a surface thereof. The study has revealed that known evaluation methods may cause variations in evaluation results for the same semiconductor substrate. The known evaluation methods therefore have insufficient evaluation accuracy.

Accordingly, an object of the present invention is to provide higher evaluation accuracy.

To achieve the above object, a method for evaluating a semiconductor substrate according to the present invention includes the steps of cleaning the semiconductor substrate with a sulfuric acid/hydrogen peroxide mixture (SPM), attaching a liquid metal electrode to a surface of the semiconductor substrate, and applying a voltage to the semiconductor substrate.

The present inventors have studied the cause of variations in evaluation results. The study has found that the variations are due to organic materials adhering to a surface of a semiconductor substrate before a liquid metal electrode is attached to the surface thereof. Such organic materials can be removed by cleaning the semiconductor substrate with SPM before attaching the liquid metal electrode to the surface thereof to achieve higher evaluation accuracy.

In the above evaluation method, the semiconductor substrate may be a silicon-on-insulator (SOI) substrate including a silicon support, an insulating layer made of an oxide film disposed on a surface of the silicon support, and a surface silicon layer formed so that the insulating layer is disposed between the silicon support and the surface silicon layer. In this case, the evaluation method may further includes the step of removing an oxide film formed on a surface of the surface silicon layer after the step of cleaning with the SPM before the liquid metal electrode is attached to the surface of the surface silicon layer.

In the evaluation of an SOI substrate, a native oxide film formed on a surface of a surface silicon layer is removed before a liquid metal electrode is attached to the surface of the surface silicon layer. If the substrate is cleaned with SPM after the removal of the native oxide film, the SPM oxidizes the surface of the surface silicon layer to form an oxide film which degrades the evaluation accuracy. The substrate may therefore be cleaned with SPM before the removal of the oxide film to eliminate both the organic materials and the oxide film on the surface of the surface silicon layer.

The SPM used in the cleaning step may contain 96% sulfuric acid and 29% hydrogen peroxide in a volume ratio of 4:1 to 19:1 to improve the evaluation accuracy more reliably.

The semiconductor substrate may be cleaned with the SPM by bringing the surface of the semiconductor substrate into contact with the SPM at 100° C. to 160° C. to improve the evaluation accuracy more reliably. In addition, the semiconductor substrate may be cleaned with the SPM by bringing the surface of the semiconductor substrate into contact with the SPM for ten minutes or more to improve the evaluation accuracy more reliably.

Accordingly, the present invention can provide higher evaluation accuracy.

### BRIEF DESCRIPTION OF THE DRAWINGS

FIG. 1 is a flow chart of the main steps of a method for evaluating a semiconductor substrate according to an embodiment of the present invention;

FIG. 2 is a sectional view showing an example of how electrodes are attached in the evaluation of an SOI substrate;

FIG. 3A is a schematic circuit diagram of the overall SOI substrate to be evaluated, showing that parasitic capacitance occurs when organic materials adhere to a surface of the SOI substrate;

FIG. 3B is a schematic circuit diagram of a part of the SOI substrate indicated by C0 in FIG. 3A;

FIG. 4 includes equations showing that parasitic capacitance occurs when the organic materials adhere to the surface of the SOI substrate, as shown in FIGS. 3A and 3B;

FIG. 5A is a graph showing measurements by gas chromatography-mass spectrometry in the case where the SOI substrate was not cleaned with SPM;

FIG. 5B is a graph showing measurements by gas chromatography-mass spectrometry in the case where the SOI substrate was cleaned with the SPM to remove the organic materials;

FIG. 6 is a graph showing Ids-Vgs curves in the cases where the SOI substrate was cleaned and not cleaned with the SPM;

FIG. 7 is a graph showing the relationship between the time for cleaning with the SPM and flat band voltage;

FIG. 8 is a graph showing the relationship between the temperature for cleaning with the SPM and flat band voltage;

FIG. 9 is a graph showing the relationship between the sulfuric acid content of the SPM for cleaning and flat band voltage;

FIG. 10 is a flow chart of the main steps of a method for evaluating a semiconductor substrate according to another embodiment of the present invention; and

FIG. 11 is a sectional view showing an example of how an electrode is attached in the evaluation of a silicon substrate.

### DESCRIPTION OF THE PREFERRED EMBODIMENTS

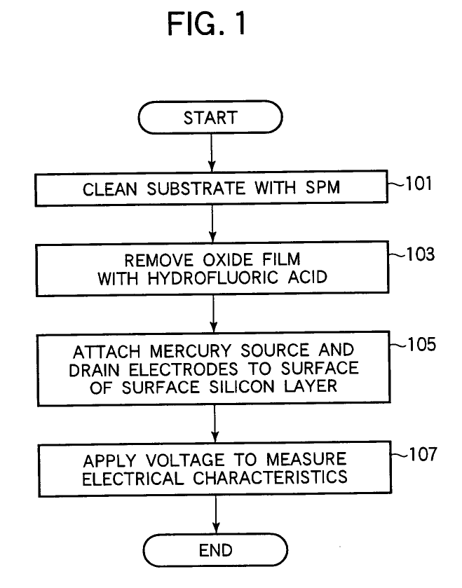

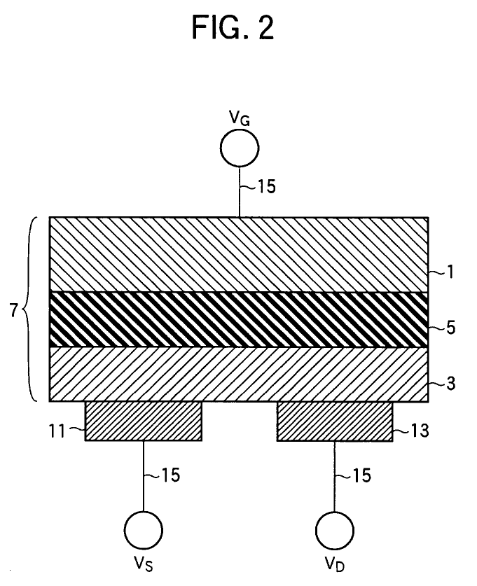

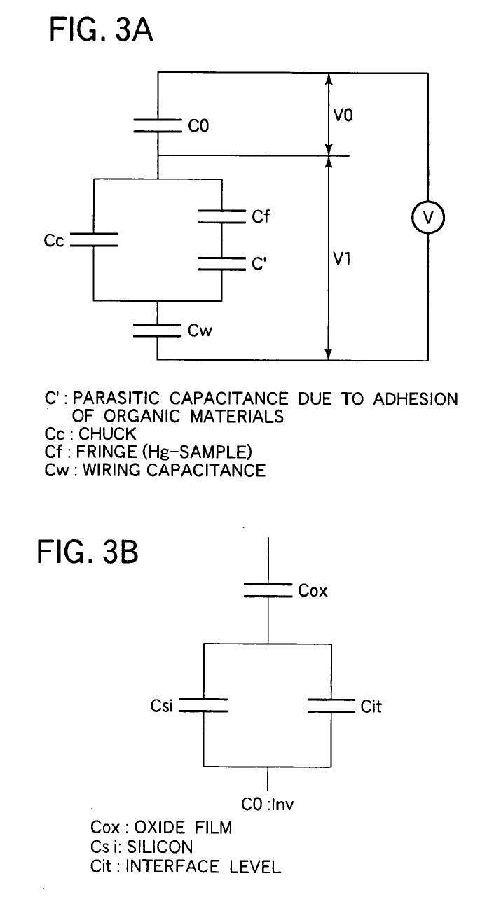

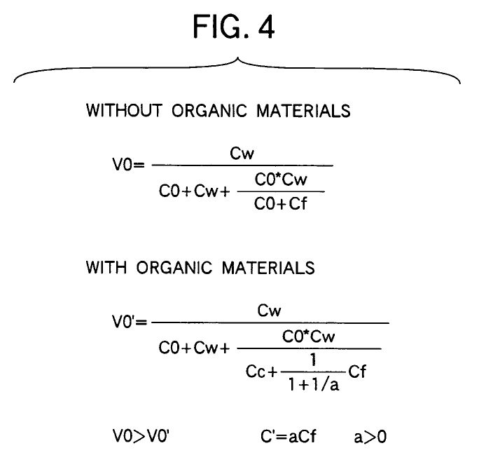

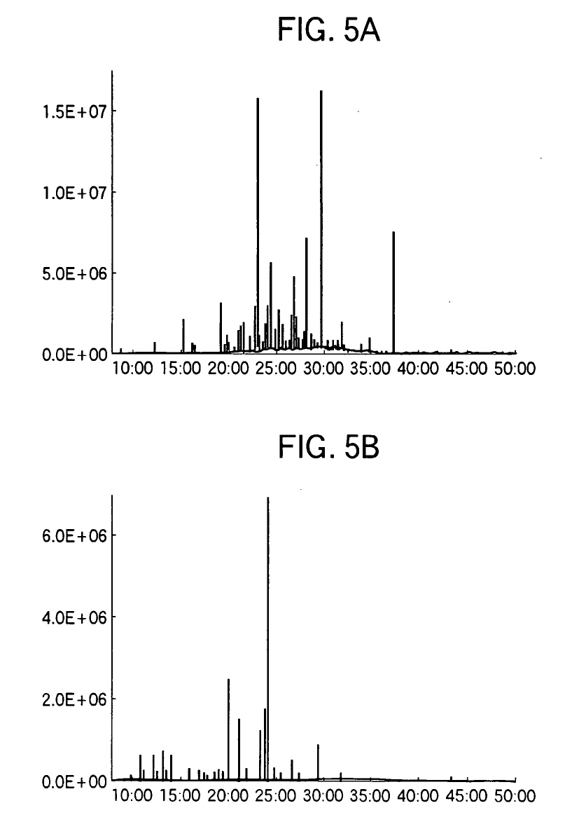

Methods for evaluating a semiconductor substrate according to embodiments of the present invention will now be described with reference to FIGS. 1 to 11. FIG. 1 is a flow chart of the main steps of a method for evaluating a semiconductor substrate according to an embodiment of the present invention. FIG. 2 is a sectional view showing an example of how electrodes are attached in the evaluation of an SOI substrate. FIGS. 3A, 3B, and 4 schematically show that parasitic capacitance occurs when organic materials adhere to a surface of the SOI substrate to be evaluated. FIG. 5A is a graph showing measurements by gas chromatography-mass spectrometry in the case where the SOI substrate was not cleaned with SPM. FIG. 5B is a graph showing measurements by gas chromatography-mass spectrometry in the case where the SOI substrate was cleaned with the SPM to remove the organic materials.

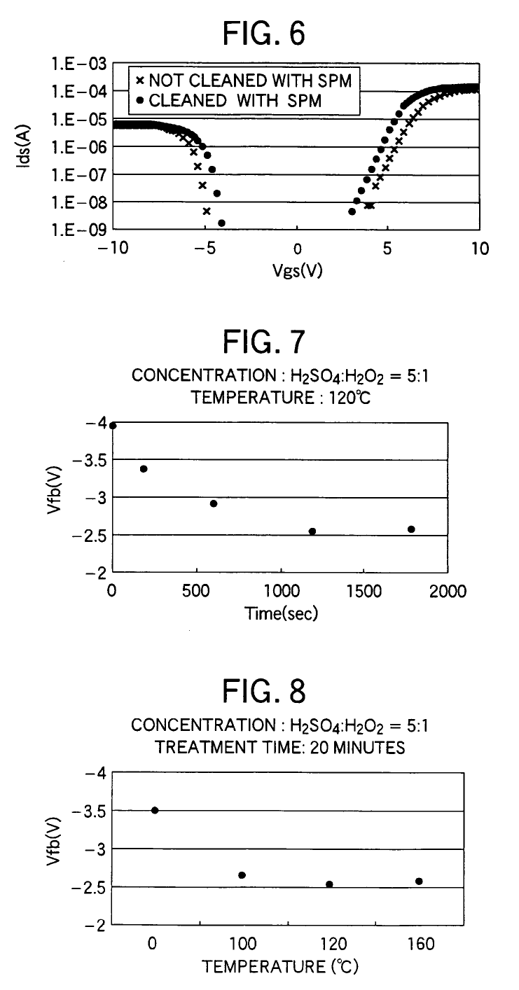

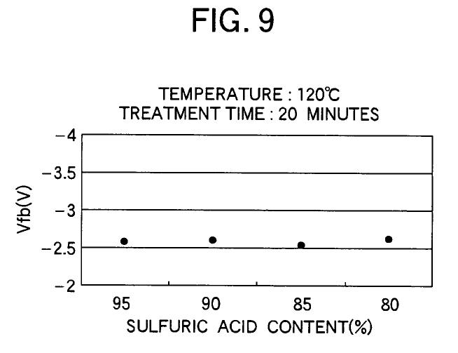

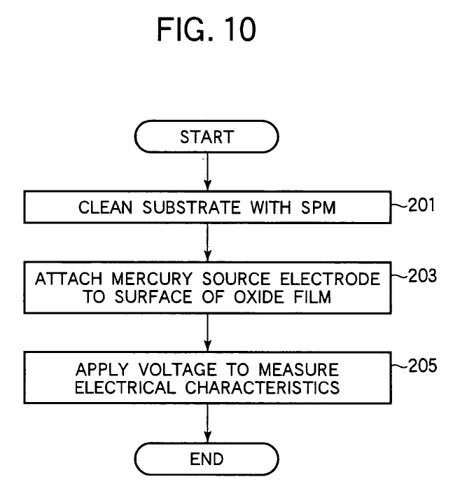

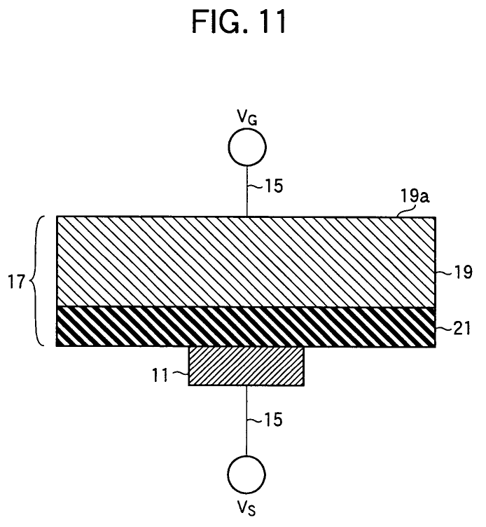

FIG. 6 is a graph showing Ids-Vgs curves in the cases where the SOI substrate was cleaned and not cleaned with the SPM. FIG. 7 is a graph showing the relationship between the time for cleaning with the SPM and flat band voltage. FIG. 8 is a graph showing the relationship between the temperature for cleaning with the SPM and flat band voltage. FIG. 9 is a graph showing the relationship between the sulfuric acid content of the SPM for cleaning and flat band voltage. FIG. 10 is a flow chart of the main steps of a method for evaluating a semiconductor substrate according to another embodiment of the present invention. FIG. 11 is a sectional view showing an example of how an electrode is attached in the evaluation of a silicon substrate.

First, a method for evaluating an SOI substrate 7 shown in FIGS. 1 and 2 is described below. This SOI substrate 7 includes a silicon support 1, a surface silicon layer 3, and an insulating layer 5 made of an oxide film and disposed therebetween. The SOI substrate 7 may be produced by, for example, SIMOX (separation by implanted oxygen) or bonding, though the evaluation method according to the present invention may be applied to semiconductor substrates produced by any method.

In SIMOX, oxygen ions are implanted into a silicon substrate which is then annealed at a predetermined temperature to form an insulating layer made of a buried oxide (BOX) film inside the silicon substrate. In bonding, a silicon substrate on which an oxide film is formed in advance is bonded to another silicon substrate, and is processed to a predetermined thickness.

In the method for evaluating a semiconductor substrate according to this embodiment, first, the SOI substrate 7 produced by, for example, SIMOX or bonding is cleaned with SPM to remove organic materials (Step 101). The SPM used for cleaning in Step 101 contains 96% sulfuric acid and 29% hydrogen peroxide in a ratio of 4:1 to 19:1. The cleaning with the SPM is performed by, for example, dipping the SOI substrate 7 in a bath filled with the SPM at 100° C. to 160° C. for ten minutes or more.

The composition of the SPM used may be suitably selected according to, for example, the types and amounts of organic materials adhering to the SOI substrate 7. In particular, the volume ratio of 96% sulfuric acid to 29% hydrogen peroxide preferably ranges from 4:1 to 19:1 to remove high-boiling organic materials on the SOI substrate 7 which are derived from clean room environments. If the ratio of 96% sulfuric acid to 29% hydrogen peroxide is less than 4, the content of 29% hydrogen peroxide is relatively high. As a result, the SPM may fail to reach a sufficiently high solution temperature because of a significant effect of the boiling point of hydrogen peroxide, depending on the apparatus used. If, on the other hand, the ratio of 96% sulfuric acid to 29% hydrogen peroxide is more than 19, the content of 29% hydrogen peroxide is relatively low. As a result, the SPM may fail to remove the high-boiling organic materials derived from clean room environments.

In addition, the temperature and time for cleaning with the SPM, namely SPM treatment temperature and time, may be suitably selected according to, for example, the types and amounts of organic materials adhering to the SOI substrate 7. The treatment with the SPM is preferably performed at 100° C. to 160° C. for ten minutes or more to ensure the effect of removing the high-boiling organic materials derived from clean room environments. If the treatment temperature is below 100° C., the SPM may fail to remove the high-boiling organic materials derived from clean room environments. If, on the other hand, the treatment temperature is above 160° C., the SPM deteriorates more quickly, and thus may fail to remove the high-boiling organic materials derived from clean room environments.

After the cleaning with the SPM in Step 101, an oxide film formed on a surface of the surface silicon layer 3 of the SOI substrate 7 is removed with, for example, hydrofluoric acid (Step 103). In Step 103, after the oxide film is removed, the surface of the surface silicon layer 3 is cleaned with pure water and is dried by a blast of N₂. Subsequently, a source electrode 11 and a drain electrode 13 are attached to the surface of the surface silicon layer 3 (Step 105). The two electrodes 11 and 13 are made of a liquid metal, namely mercury. These electrodes 11 and 13 are separated from each other on the surface of the surface silicon layer 3 so that the SOI substrate 7 functions as a pseudo-FET.

After Step 105, a power supply is connected to the silicon support 1, which functions as a gate electrode, the source electrode 11, and the drain electrode 13 via wires 15. The SOI substrate 7 is evaluated by applying a voltage between the source electrode 11 and the gate electrode, namely the silicon support 1, and between the source and drain electrode 11 and 13 and measuring current passing between the source and drain electrode 11 and 13 (Step 107). This step is performed to, for example, obtain an Ids-Vgs curve and determine the flat band voltage of the SOI substrate 7 according to the Ids-Vgs curve. Steps 103, 105, and 107 are performed in the same manner as in known methods for evaluating a semiconductor substrate.

The present inventors have studied known methods for evaluating the electrical characteristics of a semiconductor substrate by attaching a liquid metal electrode to a surface thereof. The study has revealed that known evaluation methods may cause variations in the evaluation results for the same semiconductor substrate. The known evaluation methods therefore have insufficient evaluation accuracy. In addition, the present inventors have studied the cause of the variations. The study has found that the variations are due to organic materials adhering to a surface of a semiconductor substrate before a liquid metal electrode is attached to the surface thereof.

When an electrode made of a liquid metal such as mercury is attached to a surface of a semiconductor substrate, the surface must be as clean as possible. Dust and other fine particles adhering to the surface of the semiconductor substrate lead to unstable contact with the electrode, and thus cause parasitic resistance and parasitic capacitance. Accordingly, the evaluation of a semiconductor substrate by attaching a liquid metal electrode to a surface thereof is performed in a clean environment, for example a clean room environment of Class 7 or more (ISO 14644), to prevent impurities such as dust and other fine particles from adhering to the surface of the semiconductor substrate during storage or processing for evaluation.

It is known, however, that organic materials such as high-boiling organic materials (for example, bromine-based compounds such as DOP and BHT) are released from, for example, resin ducts, filters such as HEPA filters and ULPA filters, and floor materials in clean room environments.

The present inventors have assumed that the organic materials released in clean room environments degrade the accuracy of evaluation of semiconductor substrates. The organic materials adhere to and remain on a surface of a semiconductor substrate to affect the electrical contact between the surface of the semiconductor substrate and a liquid metal electrode. This causes variations in evaluations of the same semiconductor substrate. FIGS. 3A, 3B, and 4 show that, when the organic materials adhere to the surface of the semiconductor substrate, parasitic capacitance occurs and obstructs the application of a desired voltage across terminals. This makes it difficult to perform an accurate evaluation.

The present inventors have made measurements by gas chromatography-mass spectrometry to confirm that the organic materials adhere to the surface of the semiconductor substrate. FIG. 5A shows an example of the measurements, which clearly indicates the presence of the organic materials. The inventors have also made measurements by gas chromatography-mass spectrometry on a semiconductor substrate cleaned with SPM as in Step 101 of the method for evaluating a semiconductor substrate according to this embodiment. FIG. 5B shows an example of the measurements, which clearly indicates that the organic materials were reduced. The method for evaluating a semiconductor substrate according to this embodiment therefore causes no variations in evaluations of the same semiconductor substrate, thus having higher evaluation accuracy.

As a sample of the SOI substrate 7, a p-type (boron-doped) SOI wafer having a diameter of 200 mm was evaluated by the method for evaluating a semiconductor substrate according to this embodiment. In the cleaning with SPM in Step 101, the SOI wafer was dipped in an SPM containing 96% sulfuric acid and 29% hydrogen peroxide in a volume ratio of 5:1 at 120° C. for 20 minutes. For comparison, the SOI wafer was evaluated by the method for evaluating a semiconductor substrate according to this embodiment under the same conditions except that Step 101, namely the cleaning with SPM, was not performed.

FIG. 6 shows the resultant Ids-Vgs curves. These curves indicate that the gate voltage of the wafer cleaned with the SPM was shifted to the low electric field side in absolute values in comparison with the wafer that was not cleaned with the SPM. The removal of the organic materials resulted in a reduction in the voltage due to the parasitic capacitance.

Under the above conditions, additionally, the flat band voltage of the SOI wafer was measured with varying SPM treatment times, namely the time for cleaning by dipping the SOI wafer in the SPM in Step 101, by applying a negative voltage to determine the relationship between the flat band voltage and the treatment time. According to the results shown in FIG. 7, when the wafer was cleaned with the above SPM at 120° C., the effect of the organic materials could be reliably reduced with a treatment time of ten minutes or more.

Under the above conditions, additionally, the flat band voltage of the SOI wafer was measured with varying SPM treatment temperatures, namely the temperature of the SPM for cleaning the SOI wafer in Step 101, by applying a negative voltage to determine the relationship between the flat band voltage and the treatment temperature. According to the results shown in FIG. 8, when the wafer was cleaned with the above SPM for 20 minutes, the effect of the organic materials could be reliably reduced with a treatment temperature of 100° C. or more. In addition, the treatment temperature is preferably 160° C. or less because the effect of the organic materials could not be reliably reduced at treatment temperatures above 160° C.

Under the above conditions, additionally, the flat band voltage of the SOI wafer was measured with varying sulfuric acid concentrations of the SPM for cleaning the SOI wafer in Step 101, by applying a negative voltage to determine the relationship between the flat band voltage and the sulfuric acid content. According to the results shown in FIG. 9, the effect of the organic materials could be reliably reduced when the content of 96% sulfuric acid in the SPM was within the range of 80% to 95%, namely 4:1 to 19:1 in terms of the volume ratio of 96% sulfuric acid to 29% hydrogen peroxide.

In the method for evaluating a semiconductor substrate according to this embodiment, as described above, organic materials are removed from a semiconductor substrate by cleaning with SPM before a liquid metal electrode is attached to a surface of the semiconductor substrate. This method can therefore reduce the effect of the organic materials on the evaluation results of the electrical characteristics of the semiconductor substrate to provide higher evaluation accuracy.

In addition, the evaluation accuracy can be more reliably improved by cleaning the semiconductor substrate with an SPM containing 96% sulfuric acid and 29% hydrogen peroxide in a volume ratio of 4:1 to 19:1. The evaluation accuracy can be more reliably improved by bringing the surface of the semiconductor substrate into contact with the SPM at 100° C. to 160° C. The evaluation accuracy can be more reliably improved by bringing the surface of the semiconductor substrate into contact with the SPM for ten minutes or more.

Furthermore, as in this embodiment, an SOI substrate can be evaluated with higher evaluation accuracy by cleaning the substrate with SPM before removing an oxide film with, for example, hydrofluoric acid. In the evaluation of an SOI substrate, a native oxide film formed on a surface of a surface silicon layer must be removed because source and drain electrodes are attached directly to the surface of the surface silicon layer. If the substrate is cleaned with SPM after the removal of the native oxide film, the SPM oxidizes the surface of the surface silicon layer to form an oxide film. This oxide film obstructs the direct contact between the source and drain electrodes and the surface of the surface silicon layer, thus degrading the evaluation accuracy. The substrate may therefore be cleaned with SPM before the removal of the oxide film to improve the evaluation accuracy more reliably.

The evaluation of an SOI substrate has been described as an example in this embodiment, though the method for evaluating a semiconductor substrate according to the present invention may also be applied to the measurement of the electrical characteristics of, for example, a silicon wafer including a silicon layer and an oxide film formed thereon. Referring to FIGS. 10 and 11, a silicon substrate 17 is cleaned with SPM to remove organic materials in Step 201, as in Step 101 of the above method for evaluating the SOI substrate 7.

After the cleaning with SPM in Step 201, a source electrode 11 made of a liquid metal such as mercury is attached to a surface of an oxide film 21 formed on a silicon layer 19 (Step 203). After Step 203, a power supply is connected to a surface 19a of the silicon layer 19, which functions as a gate electrode, and the source electrode 11 via wires 15, and a voltage is applied between the surface 19a of the silicon layer 19 and the source electrode 11 to evaluate the electrical characteristics of the silicon substrate 17 (Step 205).

The liquid metal used is mercury in this embodiment, but may also be, for example, gallium containing indium, tin, or a mixture thereof.

The conditions for cleaning with SPM, such as the composition of SPM, the treatment temperature, and the treatment time, may be suitably changed and adjusted according to clean room environments because the amount of organic materials released in a clean room environment, for example, varies depending on the cleanliness level of the clean room environment. The SPM cleaning conditions shown in the above embodiment can provide higher evaluation accuracy irrespective of the cleanliness level of the clean room environment, for example the amount of organic materials released.

1. A method for evaluating a semiconductor substrate, comprising the steps of:
cleaning the semiconductor substrate with a sulfuric acid/hydrogen peroxide mixture (SPM);
attaching a liquid metal electrode to a surface of the semiconductor substrate; and
applying a voltage to the semiconductor substrate.

2. The method for evaluating a semiconductor substrate according to claim 1,
wherein the semiconductor substrate is a silicon-on-insulator (SOI) substrate including a silicon support, an insulating layer made of an oxide film disposed on a surface of the silicon support, and a surface silicon layer formed so that the insulating layer is disposed between the silicon support and the surface silicon layer,
the method further comprising the step of removing an oxide film formed on a surface of the surface silicon layer after the step of cleaning with the SPM before the liquid metal electrode is attached to the surface of the surface silicon layer.

3. The method for evaluating a semiconductor substrate according to claim 1 or 2, wherein the SPM used in the cleaning step comprises 96% sulfuric acid and 29% hydrogen peroxide in a volume ratio of 4:1 to 19:1.

4. The method for evaluating a semiconductor substrate according to claim 3, wherein the semiconductor substrate is cleaned with the SPM by bringing the surface of the semiconductor substrate into contact with the SPM at 100° C. to 160° C.

5. The method for evaluating a semiconductor substrate according to claim 3, wherein the semiconductor substrate is cleaned with the SPM by bringing the surface of the semiconductor substrate into contact with the SPM for ten minutes or more.

6. The method for evaluating a semiconductor substrate according to claim 4, wherein the semiconductor substrate is cleaned with the SPM by bringing the surface of the semiconductor substrate into contact with the SPM for ten minutes or more.
